(19) United States
(12) Patent Application Publication
(10) Pub. No.: US 2024/0385204 A1
(43) Pub. Date: Nov. 21, 2024

(54) APPARATUS AND METHODS OF MONITORING ITEMS IN DIAGNOSTIC LABORATORY SYSTEMS

(71) Applicant: Siemens Healthcare Diagnostics Inc., Tarrytown, NY (US)

(72) Inventors: Yao-Jen Chang, Princeton, NJ (US); Rayal Raj Prasad Nalam Venkat, Princeton, NJ (US); Benjamin S. Pollack, Jersey City, NJ (US); Ankur Kapoor, Plainsboro, NJ (US)

(73) Assignee: Siemens Healthcare Diagnostics Inc., Tarrytown, NY (US)

(21) Appl. No.: 18/570,544

(22) PCT Filed: Jun. 15, 2022
(86) PCT No.: PCT/US2022/072944

§ 371 Date: Dec. 14, 2023

Related U.S. Application Data
(60) Provisional application No. 63/210,944, filed on Jun. 15, 2021.

(51) Int. Cl. G01N 35/04; G01N 29/14

(52) U.S. Cl. CPC G01N 35/04; G01N 29/14; G01N 2035/0405; G01N 2035/0494

(57) ABSTRACT

A method of monitoring a specimen container or specimen in a diagnostic laboratory system includes moving the specimen container on a track within the diagnostic laboratory system; moving a sensor module on the track; and monitoring at least one characteristic of the specimen container or a specimen located in the specimen container using the sensor module. Other methods, sensor modules, and diagnostic laboratory systems are disclosed.

### CROSS REFERENCE TO RELATED APPLICATION

This application claims the benefit of U.S. Provisional patent Application No. 63/210,944, entitled “APPARATUS AND METHODS OF MONITORING ITEMS IN DIAGNOSTIC LABORATORY SYSTEMS” filed Jun. 15, 2021, the disclosure of which is hereby incorporated by reference in its entirety for all purposes.

### FIELD

Embodiments of this disclosure relate to apparatus and methods of monitoring items in diagnostic laboratory systems.

### BACKGROUND

Diagnostic laboratory systems analyze specimens, such as liquid specimens obtained from patients. The specimens may include any body liquid, such as blood, urine, and other liquids. The specimens are typically received in the diagnostic laboratory systems in specimen containers (e.g., sample tubes). Components within the diagnostic laboratory systems perform actions on the specimen containers and/or the specimens located therein. The actions may include removing caps from the specimen containers (de-capping), transferring the specimen containers, identifying labels on the specimen containers, and aspirating the specimens from the specimen containers.

The diagnostic laboratory systems may be configured to receive different types of specimen containers. For example, different specimen containers may have specific shapes, colors, sizes, and/or caps that indicate the types of analyses that are to be performed on the specimens in the specimen containers or additives contained therein.

Specimen containers having new shapes, colors, sizes, and/or caps are continually introduced to the market and, thus, are received by the diagnostic laboratory systems. Extensive tests are needed to be performed for each new type of specimen container that is received in the diagnostic laboratory systems to make sure that the new types of specimen containers will function properly in the diagnostic laboratory systems. Therefore, apparatus and methods of checking compatibility of specimen containers in diagnostic laboratory systems are sought.

### SUMMARY

According to a first aspect, a method of monitoring an item in a diagnostic laboratory system is provided. The method includes moving the item on a track within the diagnostic laboratory system, moving a sensor module on the track, and monitoring at least one characteristic of the item using the sensor module.

According to a second aspect, a method of monitoring a specimen container or a specimen in a diagnostic laboratory system is provided. The method includes moving the specimen container on a track within the diagnostic laboratory system, moving a sensor module on the track, and monitoring at least one characteristic of the specimen container or the specimen located in the specimen container using the sensor module.

In another aspect, a sensor module is provided. The sensor module includes at least one sensor configured to monitor at least one characteristic of an item configured to be transported on a track in a diagnostic laboratory system, and a transport component configured to transport the sensor module on the track in the diagnostic laboratory system.

Still other aspects, features, and advantages of this disclosure may be readily apparent from the following description and illustration of a number of example embodiments, including the best mode contemplated for carrying out the disclosure. This disclosure may also be capable of other and different embodiments, and its several details may be modified in various respects, all without departing from the scope of the disclosure. This disclosure is intended to cover all modifications, equivalents, and alternatives falling within the scope of the claims.

### BRIEF DESCRIPTION OF THE DRAWINGS

The drawings, described below, are for illustrative purposes, and are not necessarily drawn to scale. Accordingly, the drawings and descriptions are to be regarded as illustrative in nature, and not as restrictive. The drawings are not intended to limit the scope of the disclosure in any way.

FIG. 1 illustrates a block diagram of a diagnostic laboratory system including a sensor module according to one or more embodiments.

FIG. 2A illustrates a side elevation view of a sensor module and a specimen container located within a carrier, the sensor module and the carrier on a track of a diagnostic laboratory system according to one or more embodiments.

FIG. 2B illustrates a side elevation view of a sensor module and a specimen container located within a carrier, the sensor module and the specimen container located on a transport component of a diagnostic laboratory system according to one or more embodiments.

FIG. 3A illustrates a side elevation view of a sensor module monitoring a carrier and a specimen container in a diagnostic laboratory system, wherein a gripper assembly is positioned to contact the specimen container according to one or more embodiments.

FIG. 3B illustrates the sensor module, the carrier, the specimen container, and the gripper assembly of FIG. 3A, wherein gripper fingers of the gripper assembly are interacting with the specimen container according to one or more embodiments.

FIG. 4 illustrates a side elevation view of an embodiment of a sensor module monitoring an interaction between a specimen container and a gripper assembly, wherein the specimen container is different than the specimen container of FIGS. 3A-3B according to one or more embodiments.

FIG. 5 illustrates a side elevation view of an embodiment of a sensor module monitoring an interaction between a specimen container and a gripper assembly, wherein the specimen container is different than the specimen containers of FIGS. 3A, 3B, and 4 according to one or more embodiments.

FIG. 6 illustrates a side elevation view of a sensor module monitoring an aspiration device of a diagnostic laboratory system interacting with a specimen container according to one or more embodiments.

FIG. 7 illustrates a side elevation view of a sensor module monitoring an aspiration device of a diagnostic laboratory system interacting with a specimen container that is not compatible with a carrier or in a collision with a specimen container according to one or more embodiments.

FIG. 8 illustrates a side elevation view of a sensor module and a generic item, the sensor module and the generic item on a track of a diagnostic laboratory system according to one or more embodiments.

FIG. 9 is a flowchart illustrating a method of monitoring an item in a diagnostic laboratory system according to one or more embodiments.

FIG. 10 is a flowchart illustrating a method of monitoring a specimen container in a diagnostic laboratory system according to one or more embodiments.

### DETAILED DESCRIPTION

Diagnostic laboratory systems analyze specimens, such as liquid specimens obtained from patients. The specimens may include any body liquid, such as blood, urine, cerebrospinal fluid, and other liquids. The specimens are typically collected in specimen containers, which are received in the diagnostic laboratory systems. The analyses may include identifying one or more analytes in the specimens and/or identifying concentrations of one or more analytes in the specimens.

The diagnostic laboratory systems may be configured to receive different types of specimen containers. The different types of specimen containers may differ by the analyses (e.g. tests) that are to be performed on the specimens in the specimen containers, the type of additive contained in the specimen container, and/or the manufacturer of the specimen container. For example, different specimen containers may have specific shapes, colors, sizes, and/or caps that indicate the types of analyses that are to be performed on specimens in the specimen containers, the additive contained therein, and/or the manufacturer of the specimen container.

Specimen containers having new shapes, colors, sizes, and/or caps may be introduced to the market and, thus, may be received by the diagnostic laboratory systems from time to time. Extensive tests are needed to be performed to determine whether each new type of specimen container to be received in the diagnostic laboratory systems will properly function with the various components contained in the diagnostic laboratory systems. For example, components such as robotic arms, specimen container carriers, de-cappers, centrifuges, quality check modules, aspiration devices, aliquoters, and other components have to be tested with the new types of specimen containers to make sure that the new types of specimen containers are compatible and can be used with the various components.

The specimen containers may be moved throughout a diagnostic laboratory system by a transport system. In some embodiments, the transport system may include carriers that carry the specimen containers on a track or the like throughout the diagnostic laboratory system. The transport system may move the specimen containers to the various components in the diagnostic laboratory system where actions are performed on the specimen containers and/or the specimens therein as described herein.

The diagnostic laboratory system may also transport generic items, such as reagent packages and supplies used by components and/or analyzers of the diagnostic laboratory system. Components of the diagnostic laboratory system may interact with such generic items, such as removing the items from a transport component of the transport system.

The apparatus and methods described herein provide for monitoring specimen containers and other items in diagnostic laboratory systems to determine whether the specimen containers and other items are compatible with components in the diagnostic laboratory systems. The methods and apparatus described herein describe monitoring specimen containers (and/or possibly specimens located therein) and/or carriers of the specimen containers. However, the apparatus and methods may monitor generic items, such as packages or reagents (e.g., reagent packs) and other generic items used by the diagnostic laboratory system.

The apparatus includes a sensor module configured to move on the same track as a specimen container. The sensor module has one or more sensors configured monitor at least one characteristic of the specimen container or a specimen located in the specimen container. In some embodiments, the one or more sensors monitor the one or more characteristics while actions are performed on the specimen container by a component or components in the diagnostic laboratory system. Based on the monitoring, the diagnostic laboratory system or a user of the diagnostic laboratory system may determine whether the new type of specimen container is compatible and can be used with one or more components of the diagnostic laboratory system.

In some embodiments, a sensor may be a vibration sensor and a characteristic that is monitored is vibration. In some embodiments, a sensor is an imaging device configured to capture an image of at least the specimen container. In some embodiments wherein a sensor is an imaging device, a characteristic to be monitored is tilt, height of the specimen in the specimen container, and/or status of a cap configured to be located on the specimen container. In some embodiments, a sensor is an acoustic sensor configured to monitor sound. In such an embodiment, the characteristic is sound. In some embodiments, the monitoring includes monitoring at least one interaction between the specimen container and a component that is moveable or contains a moveable subcomponent of the diagnostic laboratory system. In such an embodiment, a characteristic may be location of the moveable component or subcomponent relative to the specimen container, sound generated during the interaction, and/or pressure applied to the specimen container during the interaction.

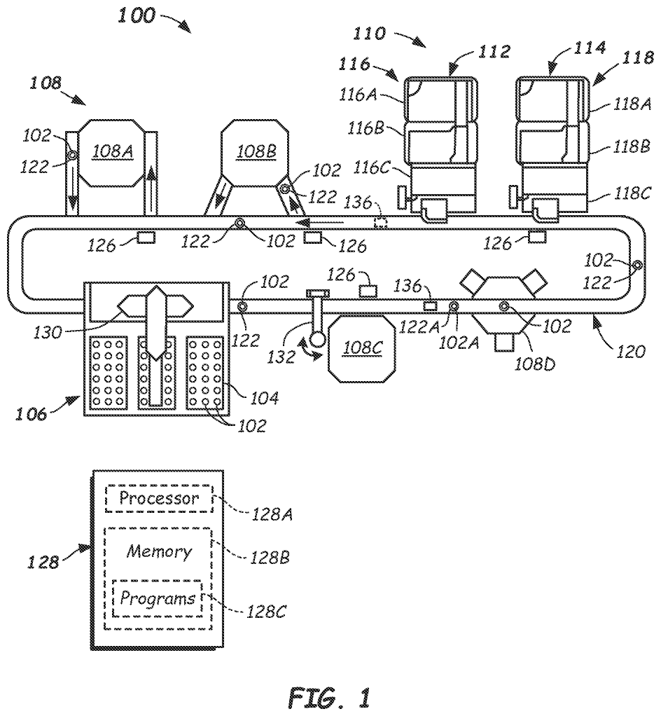

These and other methods and apparatus are described in greater detail with reference to FIGS. 1-10 herein.

Reference is now made to FIG. 1, which illustrates an example embodiment of a diagnostic laboratory system 100 configured to process and/or analyze biological specimens contained in specimen containers 102. The specimen containers 102 may be stored in one or more racks 104 provided at a loading area 106. The processing may include preprocessing or pre-screening of the specimens and/or the specimen containers 102 prior to analysis by one or more modules 108. The diagnostic laboratory system 100 may also include one or more instruments 110, wherein each instrument may include one or more modules that may be similar to one or more of the modules 108.

In the embodiment of FIG. 1, the diagnostic laboratory system 100 may include a first instrument 112 and a second instrument 114 that may perform different processes on the specimens and/or the specimen containers 102. The embodiment of the first instrument 112 depicted in FIG. 1 includes three modules 116 that are referred to individually as a first module 116A, a second module 116B, and a third module 116C. In some embodiments, the modules 116 may include a preprocessing module that processes the specimen containers 102 and/or specimens located therein. The modules 116 may also include one or more analyzer modules that analyze specimens as described herein. The embodiment of the second instrument 114 depicted in FIG. 1 includes three modules 118 that are referred to individually as a first module 118A, a second module 118B, and a third module 118C. The instruments may include fewer or more modules.

The embodiment of FIG. 1 includes four modules 108, which are referred to individually as a first module 108A, a second module 108B, a third module 108C, and a fourth module 108D. One or more of the modules 108 may be a preprocessing module, which may be a decapper, a centrifuge, a quality check module, an aliquoter, and the like, for example. The diagnostic laboratory system 100 may include other types of preprocessing modules. In some embodiments, one or more of the modules 108 may be one or more clinical chemistry analyzers or assay instruments. The modules 116 and the modules 118 in the instruments 110 may be identical or similar to the modules 108. More or fewer modules 108 and instruments 110 may be included in the diagnostic laboratory system 100.

The specimen containers 102 may be located in or on carriers 122. A track 120 may be operational to move the carriers 122 with the specimen containers 102 located therein on the track 120 throughout the diagnostic laboratory system 100. In some embodiments, the track 120 may move the carriers 122 between different ones of the modules 108, the instruments 110, and other components of the diagnostic laboratory system 100. In some embodiments, the carriers 122 may be self-propelled and the track 120 may enable the carriers 122 to move the specimen containers 102 throughout the diagnostic laboratory system 100.

In some embodiments, the track 120 may be a railed track (e.g., monorail track or multiple rail track), a collection of conveyor belts, chains, propelled or otherwise moveable platforms, or other suitable conveyance mechanisms. The track 120 may have a circular, serpentine, or other shape, and may be a closed (i.e., never ending) track in some embodiments. The track 120 may transport individual ones of the specimen containers 102 in the carriers 122. In other embodiments, multiple ones of the specimen containers 102 may be transported in single carriers. The specimen containers 102 may be configured to be moved by the carriers 122 in an upright orientation. In the depicted embodiment, the carriers 122 may be configured to stop at predetermined locations along the track 120, such as to undergo processing by the modules 108 and the instruments 110. In some embodiments, the carriers 122 may be configured to stop at predetermined locations to deliver generic items thereto.

The diagnostic laboratory system 100 may include one or more position sensors 126 that detect the positions of the specimen containers 102 and/or the carriers 122 within the diagnostic laboratory system 100. In some embodiments, position sensors (not shown in FIG. 1) may be located within the modules 108 and/or the instruments 110. In some embodiments, the position sensors 126 may include optical devices (not shown) that detect the positions of the specimen containers 102 and/or the carriers 122. The optical devices may read indicia on the specimen containers 102 and/or the carriers 122 that identify the individual ones of the specimen containers 102 and/or individual ones of the carriers 122.

In some embodiments, the position sensors 126 may include or comprise other sensors, such as RFID devices, to detect the locations of the specimen containers 102 and/or the carriers 122. For example, each of the specimen containers 102 and/or the carriers 122 may have a unique RFID tag (not shown) that identifies individual ones of the specimen containers 102 and/or the carriers 122. The position sensors 126 may include RFID readers that read the RFID tags, and in turn identify the positions of the specimen containers 102 and/or the carriers 122 within the diagnostic laboratory system 100.

The diagnostic laboratory system 100 may include a computer 128 or be configured to communicate with the computer 128. The computer 128 may be a microprocessor-based central processing unit (CPU), and include suitable memory, software, and conditioning electronics and drivers configured to operate the various components and subcomponents of the diagnostic laboratory system 100. The computer 128 may include a processor 128A and memory 128B, wherein the processor 128A is configured to execute programs 128C stored in the memory 128B. The computer 128 may be housed as part of, or separate from, the diagnostic laboratory system 100. The programs 128C may operate components, including the modules 108 and instruments 110 and may operate the transportation system as well, of the diagnostic laboratory system 100 and may perform analyses as described herein. In some embodiments, the computer 128 may be configured to communicate with separate workstation computers associated with the various modules 108 and instruments 110.

In some embodiments, the diagnostic laboratory system 100 may include a robot 130 that may be configured to pick up specific ones of the specimen containers 102 from the one or more of the racks 104 and place the specimen containers 102 into the carriers 122 located at one or more predetermined locations. In addition, the robot 130 may be configured to remove the specimen containers 102 from the carriers 122 and place the specimen containers 102 into the racks 104. The robot 130 may be operated via instructions generated by the computer 128, such as instructions generated by one or more of the programs 128C. Optionally, a separate workstation computer may be configured to communicate with computer 128 to carry out loading and unloading thereat.

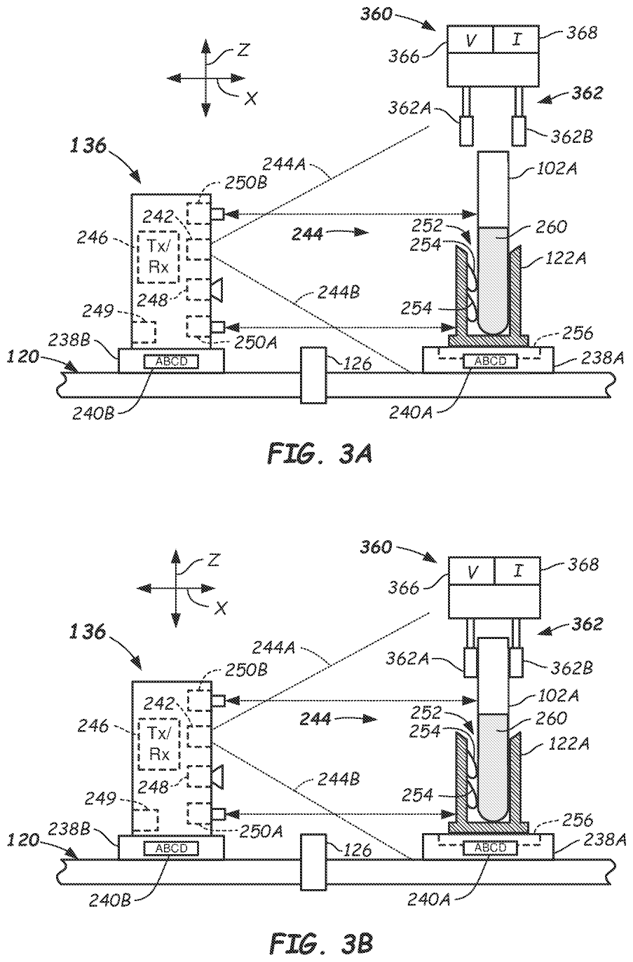

The robot 130 may include gripper fingers (e.g., gripper fingers 362-FIG. 3A) that grasp the specimen containers so that the robot 130 may transport the specimen containers 102 between the racks 104 and the carriers 122. The gripper fingers 362 may grasp the specimen containers 102 in a specific manner depending on the type of specimen container being grasped. For example, the grasping may be dependent on the height, width, and/or shape of the specimen container 102 to be grasped. The robot 130 may also transport the specimen containers 102 in a specific manner depending on the type of specimen container 102 being transported. If the robot 130 improperly transports a specimen container 102, the specimen container 102 may collide with a component or subcomponent of the diagnostic laboratory system 100. In some embodiments, the collision may damage the component, the robot 130, and/or the specimen containers 102. The methods and apparatus described herein may, in some embodiments, monitor an interaction between the robot 130 and the specimen containers 102 to make sure that proper grasping and transportation of the specimen containers 102 is being performed.

The diagnostic laboratory system 100 may include a robot 132 configured to transport the specimen containers 102 between the carriers 122 and the third module 108C. The robot 132 may include gripper fingers similar or identical to the gripper fingers 362 of the robot 130. As with the robot 130, if the robot 132 does not properly grasp and/or transport a specimen container 102, the specimen container 102, the robot 132, or other components within the diagnostic laboratory system 100 may be damaged. Other ones of the modules 108 and the instruments 110 in the diagnostic laboratory system 100 may include robots that are similar or identical to the robot 130 and the robot 132. Methods and apparatus are described herein that can monitor the interaction between the robot 132 and the specimen containers 102 and determine an effectiveness of the interaction.

As described herein, the diagnostic laboratory system 100 may include many moveable components that interact with the specimen containers 102 and/or the specimens located therein. Some of the interactions may move the specimen containers 102 and some interactions may access the specimens located within the specimen containers 102 (e.g., aspiration and/or dispense actions). When one or more new types of the specimen containers 102 are to be introduced to the diagnostic laboratory system 100, the programs 128C need to be revised to control the components within the diagnostic laboratory system 100 so as to correctly operate with the new specimen containers 102.

For example, when a new type of the specimen containers 102 is introduced that is shorter than previous ones of the specimen containers 102, the instructions that operate at least the robot 130, the robot 132, and other system robots, may be revised to cause the robots to grasp and/or transport the shorter ones of the specimen containers 102. The methods and apparatus described herein monitor the one or more robots to make sure they operate correctly with the new types of specimen containers 102.

The diagnostic laboratory system 100 may include a one or more sensor modules 136 that are configured to move within the diagnostic laboratory system 100 on the same track 120 as at least one of the specimen containers 102 and/or at least one of the carriers 122. Other like sensor modules 136 may be included and moveable elsewhere on the track 120. In the embodiment of FIG. 1, the sensor module 136 and a specimen container 102A held in a carrier 122A are shown moving on the track 120. The carrier 122A may be identical or substantially similar to the carriers 122. The sensor module 136 may follow or trail the specimen container 102A and the carrier 122A as the carrier 122A transports the specimen container 102A on the track 120. In some embodiments, the sensor module 136 may lead (i.e., be ahead of) the specimen container 102A on the track 120.

The sensor module 136 includes one or more sensors that are configured to monitor the carrier 122A and/or the specimen container 102 located in the carrier 122A. In some embodiments, the sensor module 136 monitors the specimen container 102A and/or the carrier 122A during one or more interactions between one or more components or subcomponents in the diagnostic laboratory system 100 and the specimen container 102A and/or the carrier 122A. In some embodiments, the one or more sensors may monitor the specimen container 102A as the carrier 122A transports the specimen container 102A within the diagnostic laboratory system 100. In some embodiments, the one or more sensors may monitor the specimen container 102A and/or the carrier 122A at a first time and at a subsequent second time. In some embodiments, the one or more sensors may monitor the specimen container 102A at a first time before and at a second time after one or more interactions with one or more components of the diagnostic laboratory system 100. Software may analyze data obtained at the first time and the second time to detect certain changes, which may determine whether the specimen container 102A is compatible in the diagnostic laboratory system 100. For example, images captured by the one or more sensors may be analyzed to determine positioning of a component or subcomponent at one or more stages in the interaction between the component (or subcomponent thereof) and the specimen container 102 or specimen contained therein.

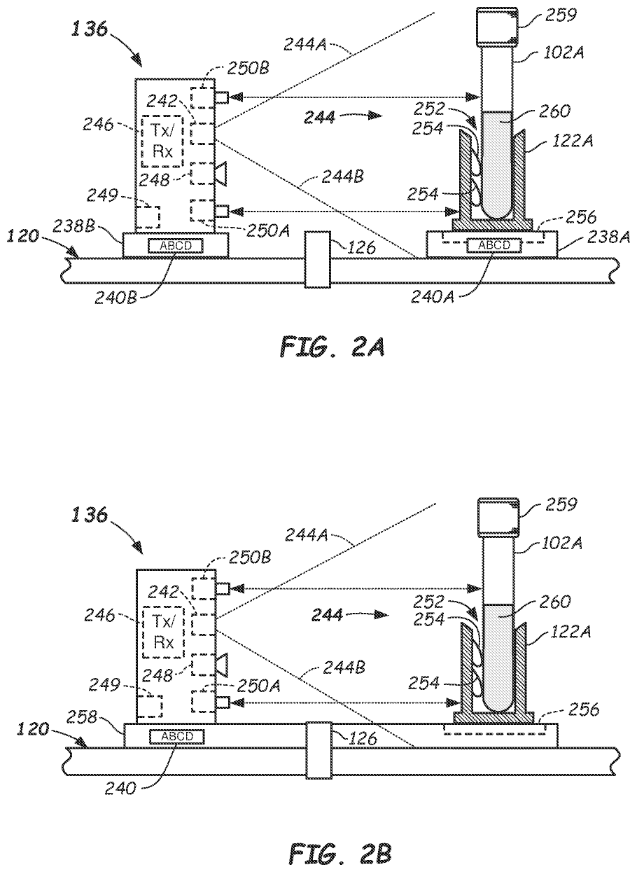

Additional reference is made to FIGS. 2A and 2B, which are side elevation views of the sensor module 136 monitoring the specimen container 102A and the carrier 122A. The sensor module 136 shown in FIGS. 2A and 2B includes one or more sensors. In some embodiments, the sensor module 136 may include more or fewer sensors than shown in FIGS. 2A and 2B. The one or more sensors may include one or more imaging devices, such as one or more cameras, CMOS sensors, sensor arrays, or other digital imaging devices.

In the embodiment of FIG. 2A, the sensor module 136 is separate from the carrier 122A and may move on the track 120 independent of the carrier 122A. However, the sensor module 136 may be configured to move on the track 120 with the carrier 122A. For example, the sensor module 136 may be configured to keep within a predetermined range of distance from the carrier 122A. In other embodiments, the sensor module 136 may be configured to be within a predetermined range of the carrier 122A or the specimen container 102A during periods when one or more sensors of the sensor module 136 are monitoring the specimen container 102A and/or the carrier 122A. The distance may be controlled by any suitable means, such as a physical spacer or connection, a distance measure, or other positioning means.

The carrier 122A may include or be coupled to a transport component 238A that is configured to transport the carrier 122A on the track 120. In some embodiments, the transport component 238A may be self-propelled, such as having a motor (electric or other) or the like that moves the transport component 238A and the carrier 122A on the track 120. The motor or the like in the transport component 238A may receive instructions to move the transport component 238A. The instructions may, as an example, be generated by the programs 128C (FIG. 1). In other embodiments, devices (not shown) proximate the track 120 may move the transport component 238A. Accordingly, in these embodiments, the transport component 238A may enable movement of the carrier 122A on the track 120. The sensor module 136 may include or be coupled to a transport component 238B. The transport component 238B may be identical or substantially similar to the transport component 238A.

In some embodiments, the sensor module 136 may be configured to stay within a predetermined range of distances from the carrier 122A when a component, such as a movable component, of the diagnostic laboratory system 100 is interacting with the specimen container 102A or when one or more sensors on the sensor module 136 are monitoring one or more characteristics of the specimen container 102A.

Some embodiments of the carrier 122A may include indicia 240A and the sensor module 136 may include indicia 240B. The indicia 240A and/or the indicia 240B may be readable by the position sensors 126. In some embodiments, the indicia 240A and the indicia 240B may be barcodes or text that are readable by the position sensors 126. When the indicia 240A or the indicia 240B is read, the position of the carrier 122A or the sensor module 136 relative to the position sensor that read the indicia 240A or the indicia 240B is known or may be interpolated. In some embodiments, the indicia 240A and/or the indicia 240B may be RFID tags and at least one of the position sensors 126 may be an RFID reader. When the position sensors 126 read the RFID tags, the position of the carrier 122A and/or the sensor module 136 may be determined. In the embodiment of FIG. 2B, a transport component 258 is configured to transport both the sensor module 136 and the carrier 122A. Therefore, a single indicium 240 may be attached to the transport component 258.

As described above, the sensor module 136 may include one or more sensors configured to monitor one or more characteristics of the specimen container 102A, the carrier 122A, and/or interactions between a moveable component or subcomponent and the specimen container 102A. In some embodiments, at least one sensor may be an imaging device 242 configured to capture images of at least a portion of the specimen container 102A. In some embodiments, the imaging device 242 also may be configured to capture images of components interacting with or that interact with the specimen container 102A at one or more stages thereof. The imaging device 242 may have a field of view 244 that is sized to capture images of the specimen container 102A and, in some embodiments, a component (or subcomponent thereof) interacting or that interact with the specimen container 102A. In the embodiment of FIG. 2A, the field of view 244 is bounded by an upper limit 244A and a lower limit 244B. The field of view 244 may be wide enough for the imaging device 242 to capture images of the specimen container 102A and, in some embodiments, one or more components (or subcomponent thereof) interacting or that interact with the specimen container 102A.

In some embodiments, the imaging device 242 may capture images of fiducial markers to determine the location of the sensor module 136. For example, the one or more position sensors 126 may include a fiducial marker on the carrier 122A that may be imaged by the imaging device 242.

The imaging device 242 captures the image(s) described herein and converts the captured image(s) to image data. The image data may be transmitted to the computer 128 (FIG. 1) by a transmitter/receiver 246. The computer 128 may then process the image data as described herein. The transmitter/receiver 246 may transmit other data and receive data and instructions, such as instructions to operate the transport component 238B, such as positioning thereof.

The imaging device 242 may monitor one or more characteristics of the specimen container 102A. In some embodiments, a characteristic is height of a specimen 260 in the specimen container 102A. In some embodiments, the characteristic is the status of a cap 259 that may be on the specimen container 102A, such as whether a cap is present and/or a color thereof. In some embodiments, a characteristic is a position of a moveable component or subcomponent relative to the specimen container 102A. In some embodiments, a characteristic to monitor is whether the specimen 260 has been spilled.

The sensor module 136 may include an acoustic sensor 248. The acoustic sensor 248 may be configured to convert sound to sound data that may be processed by the computer 128 (FIG. 1). In some embodiments, the sound data may be transmitted to the computer 128 by way of the transmitter/receiver 246. In some embodiments, the acoustic sensor 248 may be configured to receive sound proximate the acoustic sensor, which includes sound emanating from a region of the specimen container 102A. In some embodiments, the acoustic sensor 248 may be configured to receive sound from the region of the specimen container 102A and/or a component or subcomponent interacting with or configured to interact with the specimen container 102A. For example, the acoustic sensor 248 may include a directional receiver (not shown) configured to receive sound from a specific region, such as the region of the specimen container 102A. Thus, in these embodiments, the monitoring includes monitoring sound and the at least one characteristic is sound.

In some embodiments, the sensor module 136 may include one or more range finders. A first range finder 250A may be configured to measure the distance between the sensor module 136 and the carrier 122A. In some embodiments, a second range finder 250B may be configured to measure the distance between the sensor module 136 and a defined portion of the specimen container 102A. In some embodiments, the first range finder 250A and/or the second range finder 250B may use optics, such as lasers (e.g., laser distance finders), to measure the distances. Other methods, such as acoustical methods, may be used to measure the distances. The distances measured by the first range finder 250A may be used to position the sensor module 136 and the carrier 122A within a predetermined range of distances (e.g., 9 cm to 10 cm) there between. In some embodiments, the range information maybe transmitted to the computer 128 via the transmitter/receiver 246. The computer 128 may then generate instructions to move the sensor module 136 or the carrier 122A to maintain the predetermined range of distances between the sensor module 136 and the carrier 122A. In some embodiments, processing within the sensor module 136 maintains the predetermined range of distances by generating internal instructions that maintain the predetermined range of distances.

In some embodiments, the distance measured by the second range finder 250B may be used to determine the position of the specimen container 102A relative to the carrier 122A. In some embodiments, the distance measured by the second range finder 250B may be used to measure pose (e.g., a degree of tilt) of the specimen container 102A.

In some embodiments, the sensor module 136 may include a vibration sensor 249 configured to monitor vibration. Thus, the monitoring may include monitoring vibration that may occur during interaction between a moveable component or subcomponents and the specimen container 102A. For example, vibration of the specimen container 102A, the carrier 122A, or the transport component 238A may be monitored, which may be indicative of a collision between the component or subcomponent and the specimen container 102A.

The carrier 122A of FIG. 2A is shown in cross-section. The carrier 122A includes an opening 252 that is configured to receive the specimen container 102A. In some embodiments, the opening 252 includes one or more retention devices 254 configured to maintain the specimen container 102A securely within the opening 252 and in an upright orientation. In the embodiment of FIG. 2A, the retention devices 254 may be spring devices that retain the specimen container 102A in the opening 252 in a generally upright orientation.

In some embodiments, the carrier 122A may be set upon or have integrated there into a pressure sensor 256. The pressure sensor 256 may measure or monitor pressure (e.g. force) applied to the specimen container 102A and/or the carrier 122A when a component or subcomponent of the diagnostic laboratory system 100 interacts with the specimen container 102A and/or the carrier 122A. Pressure data generated by the pressure sensor 256 may be transmitted to the computer 128 via a transmitter/receiver (not shown). Thus, in such embodiments, a characteristic to be monitored is pressure applied to the specimen container 102A.

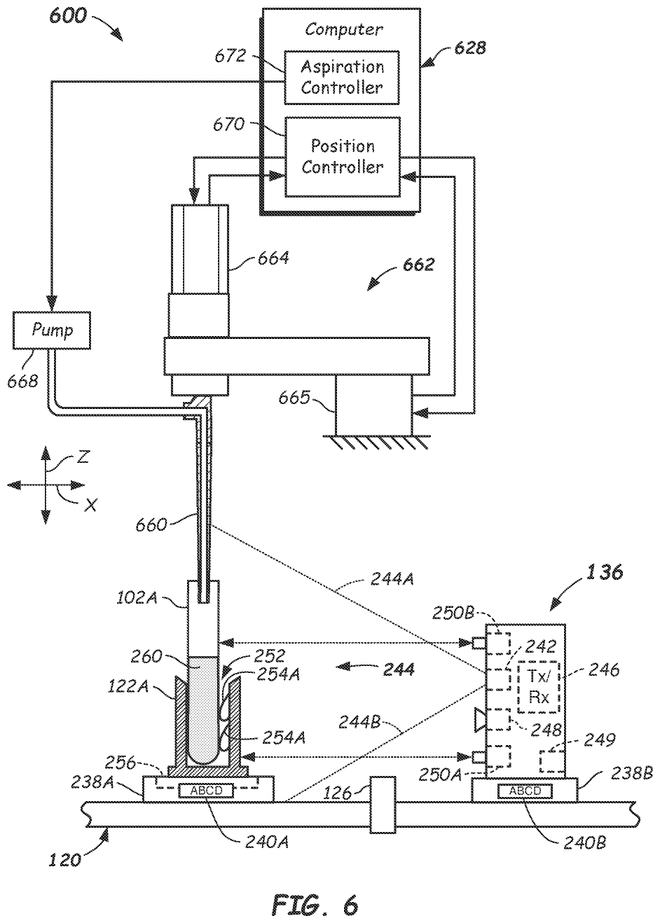

In the embodiment of FIG. 2A, the specimen container 102A includes a cap 259 and a specimen 260 is located in the specimen container 102A. The cap 259 may be removed by a cap remover (de-capper not shown) wherein interaction between the cap remover and the cap 259 may be monitored by the sensor module 136. The specimen 260 may be removed by an aspiration device (e.g., aspiration device 600-FIG. 6) wherein the interaction between the aspiration device and the specimen 260 and/or the specimen container 102A may be monitored by the sensor module 136. In these embodiments, the cap remover and the aspiration device include movable components (which may be subcomponents).

Additional reference is made to FIG. 2B, which illustrates an embodiment wherein the sensor module 136 is physically coupled to the carrier 122A. In the embodiment of FIG. 2B, the sensor module 136 and the carrier 122A are coupled to a transport component 258. The transport component 258 moves the sensor module 136 and the carrier 122A together on the track 120. Thus, the distance between the sensor module 136 and the carrier 122A is maintained at a predetermined distance. In some embodiments, the pressure sensor 256 may be incorporated into the transport component 258 or located on the transport component 258 and may be configured to communicate with the transmitter/receiver 246 to transmit monitored pressure data to the computer 128. Thus, in such embodiments, at least one characteristic is pressure monitored by the pressure sensor 256.

The sensor module 136 may monitor the characteristics described herein to determine if the specimen container 102A is compatible with the diagnostic laboratory system 100 and the components thereof. In some embodiments, characteristics are monitored at a first time and a subsequent second time to determine if changes between the first time and the second time are indicative of incompatibility. In some embodiments, a characteristic is the height of the specimen 260, which may be monitored by the imaging device 242. If the height changes or is not at a predetermined level, the specimen container 102A may cause spillage of the specimen 260 or possibly a collision with the specimen container 102A and is therefore not compatible in the diagnostic laboratory system 100. In some embodiments, a characteristic is tilt or pose of the specimen container 102 that may be monitored by the imaging device 242. If the specimen container 102A has a tilt greater than a predetermined tilt, the specimen container 102A may not be compatible. In some embodiments, a characteristic is a status of the cap 259 that may be monitored by the imaging device 242. If the cap 259 is on when it should be off or if the cap 259 is off when it should be on, the specimen container 102A may not be compatible. In some embodiments, the color or type of the cap 259 may be monitored by the imaging device 242. If the cap 259 is the wrong color or type for the analysis ordered, the specimen container 102A may not be compatible.

Additional reference is made to FIG. 3A, which is a side elevation view of the sensor module 136 and the carrier 122A, wherein a gripper assembly 360 is positioned to contact the specimen container 102A. The gripper assembly 360 shown in FIGS. 3A and 3B is only one of many different embodiments of gripper assemblies that may be used to grasp and move the specimen container 102A. The gripper assembly 360 and the components thereof may be one or more of the movable components (including subcomponents) described herein. Similar gripper assemblies may be used in the modules 108 (FIG. 1) and/or the instruments 110 (FIG. 1). The gripper assembly 360 may be used in one or both the robot 130 (FIG. 1) and the robot 132 (FIG. 1). The gripper assembly 360 includes a plurality of gripper fingers 362 that are configured to move to grasp the specimen container 102A. The embodiment of the gripper assembly 360 includes a first finger 362A and a second finger 362B. Other numbers of gripper fingers (e.g., three or four) may be used.

The gripper fingers 362 are configured to relatively move in an X-direction to engage and disengage the specimen container 102A. The gripper fingers 362 may move in the Z-direction towards or away from the specimen container 102A. Thus, the gripper fingers 362 may move in the z-direction toward the specimen container 102A and then toward each other in the x-direction to engage the specimen container 102A as shown in FIG. 3B. The gripper fingers 362 may then move in the z-direction to extract the specimen container 102A from the carrier 122A. The reverse process may be performed to insert the specimen container 102A into the carrier 122A.

The gripper assembly 360 may include one or more servos, motors, or the like (not shown) coupled to the gripper fingers 362. Power supplied to the gripper assembly 360 may be monitored by a voltage sensor 366 and/or a current sensor 368. In some embodiments, the voltage sensor 366 and/or the current sensor 368 may be integrated within the gripper assembly 360. Voltage data generated by the voltage sensor 366 and/or current data generated by the current sensor 368 may be transmitted to the computer 128 (FIG. 1) and processed by the programs 128C. Excessive current drawn by the gripper assembly 360 may be indicative of anomalies during interactions between the gripper fingers 362 and the specimen container 102A. Excessive voltage required to move the gripper fingers 362 may also be indicative of anomalies during interactions between the gripper fingers 362 and the specimen container 102A.

In both the configurations of FIG. 3A and FIG. 3B, the carrier 122A, the specimen container 102A, and the gripper fingers 362 are in the field of view 244 of the imaging device 242. Accordingly, images of the carrier 122A, the specimen container 102A, and the gripper fingers 362 may be captured by the imaging device 242. In addition, interactions between the carrier 122A, the specimen container 102A, and the gripper fingers 362 may be captured. Image data representative of the captured images may be transmitted to the computer 128 (FIG. 1) by transmitter/receiver 246 and processed by the programs 128C of computer 128 (FIG. 1) as described herein.

In some embodiments, the acoustic sensor 248 monitors sound and may generate acoustic data representative of the sound generated during interactions between the gripper fingers 362 and the specimen container 102A. The acoustic data may be transmitted to the computer 128 (FIG. 1) via the transmitter/receiver 246. The programs 128C may analyze the acoustic data to determine if the sound is due to anomalies occurring during the interactions. The anomalies may be found to be due to incompatibility of the specimen container 102A with the gripper assembly 360.

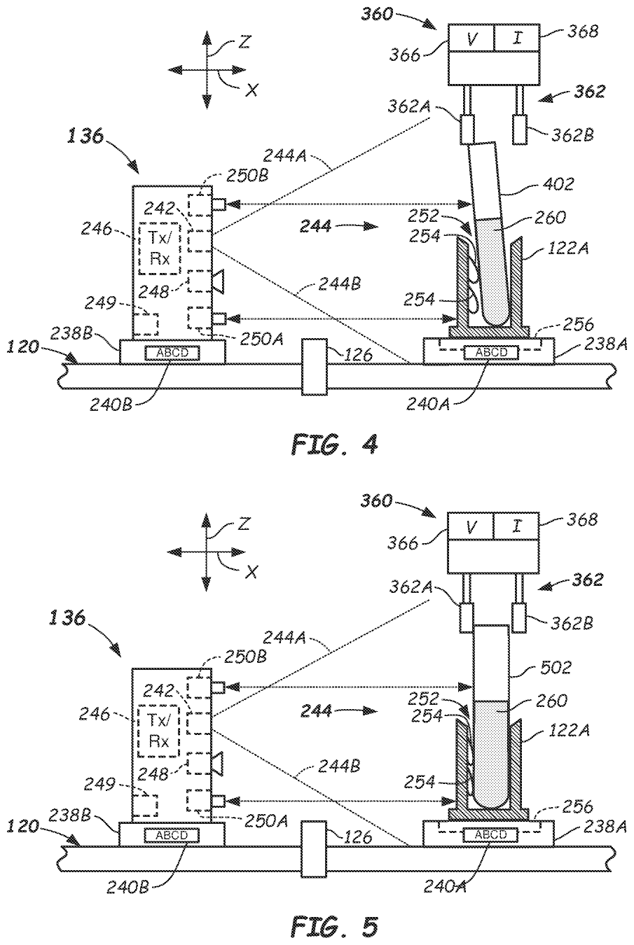

Reference is made to FIG. 4, which illustrates an embodiment of the sensor module 136 monitoring an interaction between a specimen container 402 and the gripper assembly 360. In the embodiment of FIG. 4, the specimen container 402 differs from the specimen container 102A in that the specimen container 402 is thinner than the specimen container 102A. In other embodiments, the specimen container 402 may have shapes that differ from the specimen container 102A. For example, the specimen container 402 may have shapes other than cylindrical.

As shown in FIG. 4, the size and/or the shape of the specimen container 402 prevents the specimen container 402 from being properly received in the carrier 122A. As described herein, the sensor module 136 may monitor one or more interactions between the gripper assembly 360 and the specimen container 102A. At some time, the specimen container 402 has tilted in the carrier 122A. For example, the retention devices 254 may not be able to properly retain the specimen container 402 in the carrier 122A. For example, the tilt may have occurred during loading of the specimen container 402 in the carrier 122A or movement of the carrier 122A on the track 120.

As described above, the tilt may be a characteristic monitored by the imaging device 242. The programs 128C (FIG. 1) or a user may recognize the tilt, but may have the gripper fingers 362 interact with the specimen container 402 to determine if the specimen container 402 is compatible with the gripper fingers 362 even with the tilt.

As shown in FIG. 4, the tilt of the specimen container 402 may prevent proper interaction between the gripper fingers 362 and the specimen container 402. For example, the first finger 362A may contact the top of the specimen container 402 when the gripper fingers 362 move in the Z-direction toward the specimen container 402. The contact between the specimen container 402 and the first finger 362A may be captured by the imaging device 242. The image data generated by the imaging device 242 may be analyzed by the programs 128C or a user of the diagnostic laboratory system 100. A determination that the specimen container 402 is not compatible with the gripper fingers 362 may then be made. The incompatibility may be based on a recognition of a contact between a top edge of the specimen container 402 with at least one of the gripper fingers 362.

In some embodiments, the acoustic sensor 248 may detect (e.g., monitor) sounds generated by contact between the first finger 362A and the specimen container 402. Acoustic data generated by the contact between the first finger 362A and the specimen container 402 may be analyzed by the programs 128C (FIG. 1) or a user to determine compatibility of the specimen container 402 with the gripper fingers 362. In some embodiments, the contact between the first finger 362A and the specimen container 402 may cause pressure in the pressure sensor 256 that may be transmitted as pressure data and analyzed by the programs 128C. Excessive pressure may be indicative of the specimen container 102A not being compatible with the gripper fingers 362 due to contact there between.

When the first finger 362A contacts the specimen container 402, the current and/or voltage input to the gripper assembly 360 may change. The current sensor 368 and/or the voltage sensor 366 may measure or monitor the current and/or voltage. This data in combination with the data generated by the sensor module 136 (e.g., acoustic data and/or image data) may be used to determine whether the interaction between the gripper fingers 362 and the specimen container is proper and whether the specimen container 402 is compatible with the gripper fingers 362.

Reference is made to FIG. 5, which illustrates an embodiment of the sensor module 136 monitoring an interaction between a specimen container 502 and the gripper assembly 360. In the embodiment of FIG. 5, the specimen container 502 differs from the specimen container 102A in that the specimen container 502 is wider and shorter than the specimen container 102A. In other embodiments, the specimen container 502 may have shapes that differ from the specimen container 102A. For example, the specimen container 502 may have shapes other than cylindrical.

As shown in FIG. 5, the width of the specimen container 502 provides a tight fit in the opening 252 of the carrier 122A. Accordingly, the size and/or the shape of the specimen container 502 may prevent the specimen container 502 from being properly received in and retrieved from the carrier 122A. Thus, the specimen container 502 may not be compatible with components of the diagnostic laboratory system 100. For example, the retention devices 254 may retain the specimen container 502 too tightly within the opening 252. The tight fit may prevent the gripper assembly 360 from moving or removing the specimen container 502 in the carrier 122A. In addition, the short size of the specimen container 502 may prevent the gripper fingers 362 from properly gripping the respective sides of the specimen container 502 as described herein.

As described herein, the sensor module 136 may monitor one or more interactions between the gripper assembly 360 and the specimen container 502. The width of the specimen container 502 may cause one of the gripper fingers 362 to improperly contact the specimen container 502. The imaging device 242 and the acoustic sensor 248, and/or the pressure sensor 256 may generate data in response to the improper contact between the specimen container 502 and the gripper fingers 362 as described in FIG. 4. This data may be analyzed to determine whether the specimen container 502 is compatible with the gripper fingers 362. Data from the voltage sensor 366 and/or the current sensor 368 may be used to confirm incompatibility of the specimen container 502 with the gripper fingers 362.

The tight fit of the specimen container 502 within the carrier 122A may increase force applied by the gripper assembly 360 on the specimen container 502 when the specimen container 502 is moved relative to the carrier 122A. The pressure sensor 256 may monitor the force applied by the gripper assembly 360 to move the specimen container 502. In addition, the voltage sensor 366 and/or the current sensor 368 may monitor the additional power required to move the specimen container 502. The imaging device 242 may generate image data of the specimen container 502, which may be analyzed by the programs 128C (FIG. 1) to determine the width of the specimen container 502. Based at least in part on the aforementioned data from the sensor module 136, and possibly in conjunction with other confirming data, the programs 128C may determine if the specimen container 502 is compatible with the gripper fingers 362.

As described herein, the specimen container 502 may be shorter than the specimen container 102A. The shorter size of the specimen container 502 may prevent the gripper fingers 362 from properly grasping the specimen container 502. For example, as shown in FIG. 5, the gripper fingers 362 may not fully engage the specimen container 502. The imaging device 242 may capture images of the interaction between the gripper fingers 362 and the specimen container 502. The programs 128C (FIG. 1) may analyze the image data generated by the imaging device 242 and may determine if the specimen container 502 is compatible with the gripper assembly 360. For example, a location of the gripper fingers 362 in the Z-direction relative to a top of the specimen container 502 may be analyzed to determine compatibility or incompatibility.

Reference is now made to FIG. 6, which illustrates a side elevation view of an aspiration device 600 properly interacting with the specimen container 102A. The aspiration device 600 may be configured to aspirate the specimen 260 from the specimen container 102A. In some embodiments, the aspiration device 600 may be configured to dispense the specimen 260 to other containers (not shown). In some embodiments, the aspiration device 600 may be configured to dispense liquids into the specimen container 102A. The aspiration device 600 and the components thereof may be the movable components (including subcomponents) described herein.

The aspiration device 600 includes a probe 660 (e.g., a pipette) that is configured to move into and out of the specimen container 102 to perform aspiration and/or dispense operations. Thus, the probe 660 is configured to enter the specimen container 102A to contact and aspirate the specimen 260. In the embodiment of FIG. 6, the probe 660 is properly interacting with the specimen container 102A. For example, the probe 660 has not contacted the specimen container 102A at a top thereof and is properly aligned within the interior of the specimen container 102A so to progress into contact with the specimen 260.

The aspiration device 600 may include a robot 662 coupled to the probe 660 and configured to move the probe 660 at least in the Z-direction. For example, a motor 664 may be configured to move the probe 660 in the Z-direction. In the embodiment of FIG. 6, the robot 662 may also be configured to move the probe 660 in the X-direction, which can be parallel to or perpendicular to the direction of the track 120. For example, a motor 665 may be configured to move the probe 660 in the X-direction and Z-directions. The robot 662 may be configured to move the probe 660 in other directions. The aspiration device 600 may include a pump 668 coupled to the probe 660 that is configured to aspirate and dispense liquids via the probe 660.

The components of the aspiration device 600 may be controlled by a computer 628 that may be coupled to and in communication with the computer 128 (FIG. 1). In some embodiments, the computer 628 is the same as the computer 128. The computer 628 may generate instructions that operate the motor 664, the motor 665, and the pump 668. In the embodiment of FIG. 6, the computer 628 includes a position controller 670 that generates instructions to operate the motor 664 and the motor 665. The motor 664 and the motor 665 may transmit feedback monitoring signals back to the position controller 670. The monitoring signals may include position information and/or power (voltage and/or current) drawn by the motor 664 and the motor 665. The computer 628 also may include an aspiration controller 672 configured to generate instructions that control the pump 668.

The sensor module 136 may be configured to monitor the interactions between the specimen container 102A and the aspiration device 600. The imaging device 242 may capture images of the probe 660, the specimen container 102A, the specimen 260, and/or the carrier 122A. The acoustic sensor 248 may monitor sound generated during the interactions. The pressure sensor 256 may monitor pressure applied to the carrier 122A during the interactions. The vibration sensor 249 may monitor vibration during the interactions. The data generated during the interactions may be transmitted to the computer 128 (FIG. 1) and analyzed by the programs 128C to determine compatibility of the specimen container 102A with the aspiration device 600.

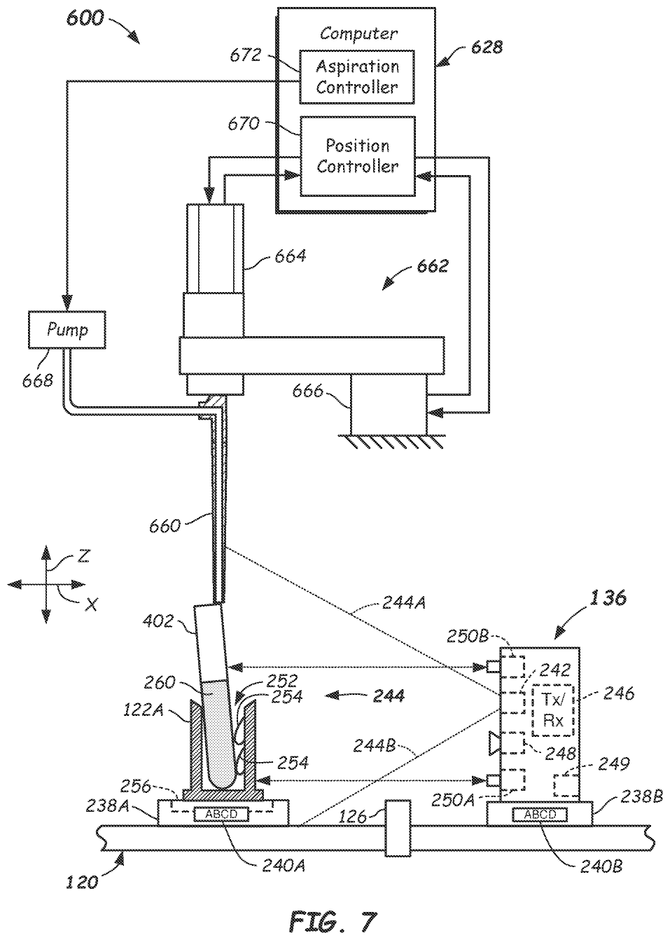

Reference is made to FIG. 7, which illustrates the aspiration device 600 interacting with the specimen container 402, which is not compatible with the carrier 122A. As described herein, the specimen container 402 is thinner than the specimen container 102A (FIG. 2A), which has caused the specimen container 402 to have considerable tilt in the carrier 122A. Images of the specimen container 402 may be captured by the imaging device 242 as described herein. Because the specimen container 402 is not compatible with the aspiration device 600, the probe 660 has collided with the specimen container 402 as the probe 660 is moved in the Z-direction toward the specimen container 402. The imaging device 242, the acoustic sensor 248, and/or the vibration sensor 249 may generate data that is analyzed by the computer 628 to determine that the specimen container 402 is not compatible with the aspiration device 600. The pressure sensor 256 may generate data that is analyzed by the computer 628 to further confirm that the specimen container 402 is not compatible.

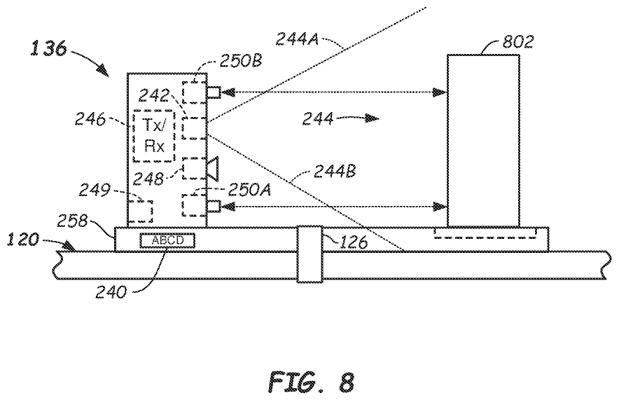

The sensor module 136 described in FIGS. 2A-7 shows the sensor module 136 monitoring the specimen container 102A and/or the carrier 122A. In some embodiments, the sensor module 136 is configured to monitor an item 802 as shown in FIG. 8. The item 802 may be a generic item that may be transported through the diagnostic laboratory system 100. In some embodiments, the item 802 may be a package containing a reagent (e.g., a reagent pack) or other package containing chemicals or liquids used by the diagnostic laboratory system 100. In other embodiments, the item 802 may be a hardware component or supply item used in the diagnostic laboratory system 100.

The sensors in the sensor module 136 may be configured to generate data relative to the item 802. For example, the imaging device 242 may be configured to capture images of at least a portion of the item 802. The imaging device 242 may be configured to capture images of at least a portion of the item 802 and at least a portion of a component or subcomponent thereof interacting with the item 802. As new types of items are introduced to the diagnostic laboratory system 100, the sensor module 136 may monitor the item 802. The programs 128C (FIG. 1) may then analyze the data generated by the sensor module 136 to determine whether the item is compatible with the diagnostic laboratory system 100.

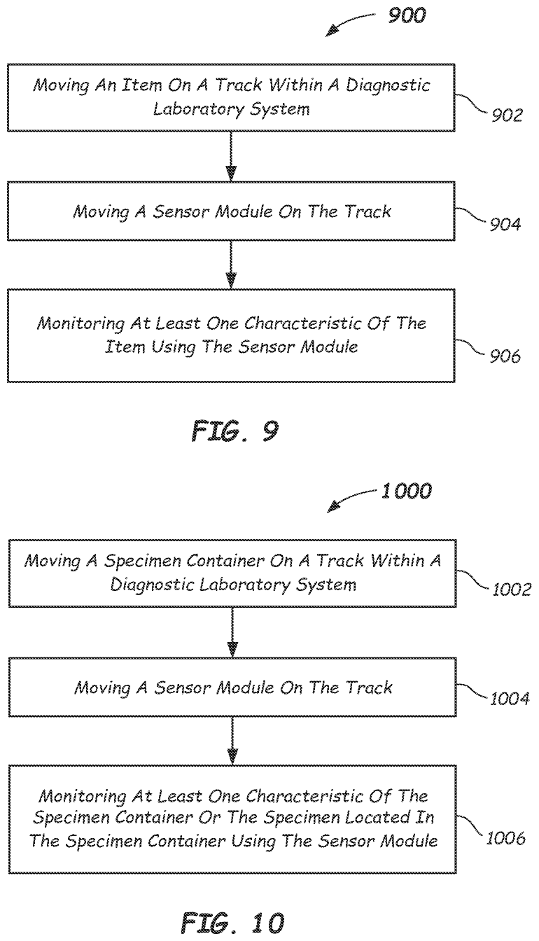

Reference is now made to FIG. 9, which is a flowchart showing a method 900 of monitoring an item (e.g., item 802) in a diagnostic laboratory system (e.g., diagnostic laboratory system 100). The method 900 includes, in 902, moving the item on a track (e.g., track 120) within the diagnostic laboratory system. The method 900 includes, in 904, moving a sensor module (e.g., sensor module 136) on the track. The method 900 includes, in 906, monitoring at least one characteristic of the item using the sensor module. In the case of monitoring an item 802, the characteristic may be location, tilt, height, and/or width of the item, and/or interaction of a component (or subcomponent thereof) with the item 802.

Reference is also made to FIG. 10, which is a flowchart showing a method 1000 of monitoring a specimen container (e.g., specimen container 102, 102A, 402, 502) or a specimen (e.g., specimen 260) in a diagnostic laboratory system (e.g., diagnostic laboratory system 100). The method 1000 includes, in 1002 moving the specimen container on a track (e.g., track 120) within the diagnostic laboratory system. The method 1000 includes, in 1004, moving a sensor module (e.g., sensor module 136) on the track. The method 1000 further includes, in 1006, monitoring at least one characteristic of the specimen container or a specimen located in the specimen container using the sensor module.

While the disclosure is susceptible to various modifications and alternative forms, specific methods, and apparatus embodiments have been shown by way of example in the drawings and are described in detail herein. It should be understood, however, that the particular methods and apparatus disclosed herein are not intended to limit the disclosure but, to the contrary, to cover all modifications, equivalents, and alternatives falling within the scope of the claims.

What is claimed is:

1. A method of monitoring an item in a diagnostic laboratory system, comprising:
moving the item on a track within the diagnostic laboratory system;
moving a sensor module on the track; and
monitoring at least one characteristic of the item using the sensor module.

2. The method of claim 1, wherein the sensor module comprises at least one sensor configured to monitor the at least one characteristic.

3. The method of claim 1, comprising locating the item on a transport component and locating the sensor module on the transport component, wherein moving the item and moving the sensor module comprises moving the transport component on the track.

4. The method of claim 1, wherein the monitoring comprises monitoring the at least one characteristic at a first time and monitoring the at least one characteristic at a subsequent second time.

5. The method of claim 1, wherein the monitoring comprises monitoring vibration.

6. The method of claim 1, wherein the monitoring comprises capturing an image including at least a portion of the item.

7. The method of claim 1, wherein the monitoring comprises monitoring sound.

8. The method of claim 1, wherein the at least one characteristic is tilt of the item.

9. The method of claim 1, wherein moving the item comprises moving a specimen container.

10. The method of claim 9, wherein the at least one characteristic is a status of a cap configured to be located on the specimen container.

11. The method of claim 9, wherein the monitoring comprises monitoring at least one interaction of the specimen container with a moveable component.

12. The method of claim 1, wherein the at least one characteristic is pressure applied to the item during an interaction with a component of the diagnostic laboratory system.

13. The method of claim 1, wherein moving the item comprises moving a reagent pack.

14. A method of monitoring a specimen container or a specimen in a diagnostic laboratory system, comprising:
moving the specimen container on a track within the diagnostic laboratory system;
moving a sensor module on the track; and
monitoring at least one characteristic of the specimen container or a specimen located in the specimen container using the sensor module.

15. The method of claim 14, wherein the sensor module comprises at least one sensor configured to monitor the at least one characteristic.

16. The method of claim 14, comprising locating the specimen container on a transport component and locating the sensor module on the transport component, wherein moving the specimen container and moving the sensor module comprises moving the transport component.

17. The method of claim 14, wherein the monitoring comprises monitoring the at least one characteristic at a first time and monitoring the at least one characteristic at a subsequent second time.

18. The method of claim 14, wherein the monitoring comprises monitoring vibration.

19. The method of claim 14, wherein the monitoring comprises capturing an image including the specimen container.

20. The method of claim 14, wherein the monitoring comprises monitoring sound.

21. The method of claim 14, wherein the at least one characteristic is tilt of the specimen container.

22. The method of claim 14, wherein the at least one characteristic is height of a specimen in the specimen container.

23. The method of claim 14, wherein the at least one characteristic is a status of a cap configured to be located on the specimen container.

24. The method of claim 14, wherein the monitoring comprises monitoring at least one interaction of the specimen container with a moveable component.

25. A sensor module comprising:
at least one sensor configured to monitor at least one characteristic of an item configured to be transported on a track in a diagnostic laboratory system; and
a transport component configured to transport the sensor module on the track in the diagnostic laboratory system.

26. The sensor module of claim 25, wherein the item is a specimen container.

27. The sensor module of claim 25, wherein at least one sensor is an imaging device configured to capture images including at least a portion of the item.

28. The sensor module of claim 25, wherein at least one sensor is an acoustic sensor.

29. The sensor module of claim 25, wherein the at least one sensor is a vibration sensor.
